(19) United States
(12) Patent Application Publication
(10) Pub. No.: US 2008/0060682 A1
(43) Pub. Date: Mar. 13, 2008

(54) HIGH TEMPERATURE SPM TREATMENT FOR PHOTORESIST STRIPPING

(75) Inventors: Matt Yeh, Hsinchu (TW); Shun-Wu Lin, Taichung City (TW); Chi-Chun Chen, Kaohsiung (TW); Shih-Chang Chen, Hsinchu (TW)

Correspondence Address: DUANE MORRIS LLP;IP DEPARTMENT (TSMC), 30 SOUTH 17TH STREET, PHILADELPHIA, PA, 19103-4196, US

(73) Assignee: TAIWAN SEMICONDUCTOR MANUFACTURING CO., LTD., Hsin-Chu (TW)

(21) Appl. No.: 11/531,598

(22) Filed: Sep. 13, 2006

(51) Int. Cl. B08B 3/00

(52) U.S. Cl. 134/28; 134/34

(57) ABSTRACT

A method for stripping photoresist and cleaning a semiconductor substrate include a high temperature stripping process in a freshly mixed SPM solution followed by cleaning in a water soluble organic co-solvent such as acetone, IPA, methanol, ethanol, butanol, or DMSO. The substrate may undergo back side heating during the SPM solution stripping process and may optionally use nanospraying techniques to direct the water soluble organic co-solvent to the substrate. The method completely strips plasma hardened photoresist using only wet chemical operations.

### FIELD OF THE INVENTION

The present invention provides a method for cleaning organic material such as photoresist from a substrate using a high temperature SPM (sulfuric peroxide mixture) solution.

### BACKGROUND OF THE INVENTION

Photoresist is an organic material that plays a critical role in the manufacture of semiconductor devices. Photoresist is used to form patterns at multiple device levels but must be completely removed prior to the formation of the subsequent device level. Failure to completely remove photoresist will result in contamination. Such contamination may cause the substrate upon which the semiconductor devices are being formed, to be scrapped, and the equipment used to process the substrate, to malfunction, resulting in considerable down time for the equipment. As such, it is important to completely remove photoresist after each processing sequence.

Lithographic methods are used to form a pattern in photoresist formed upon a layer of semiconductor material and this pattern acts as a photomask during a subsequent operation performed upon the layer of semiconductor material itself. The subsequent processing operation may be a reactive ion etching procedure, a high-energy ion implantation procedure or various other operations that harden the photomask rendering it increasingly difficult to remove the photoresist. In conventional technology, an oxygen plasma ashing process is widely used to remove hard-baked, plasma damaged or ion-implanted photoresist but there are several shortcomings associated with the use of oxygen plasma ashing. For example, plasma damage can occur and exposed silicon may be attacked resulting in silicon loss such as in the form of recesses. The majority of semiconductor devices are formed on a silicon substrate and virtually every semiconductor device includes various silicon structures that serve as various device structures. Therefore, the loss of silicon can degrade device performance and result in device failure. Plasma damage also degrades device performance in other manners that are well known in the semiconductor manufacturing industry.

As such, there have been attempts to remove photoresist, even plasma hardened, hard-baked or ion-implanted photoresist, using only wet cleaning procedures. Attempts to strip photoresist using conventional SPM (sulfuric-peroxide mixture) solutions are typically ineffective due to the low photoresist stripping rate that they produce due to the low temperatures used. Other attempts include the use of ozone dissolved in deionized, DI, water but the shortcomings associated with this technique include the inability to maintain a sufficiently high ozone concentration and a resulting low photoresist stripping rate. Attempts to use ozone in conjunction with water vapor have resulted in film loss, delamination, and damage.

It would therefore be desirable to clean a semiconductor substrate by completely stripping hardened photoresist using a wet processing cleaning sequence that provides a high photoresist stripping rate, completely cleans the substrate and does not damage the substrate.

### SUMMARY OF THE INVENTION

To address these and other needs and in view of its purposes, one aspect of the invention provides a method for cleaning a substrate. The method includes providing a substrate with photoresist thereon and mixing H₂SO₄ and H₂O₂ to produce an SPM solution in an exothermic reaction. The exothermic reaction heats the SPM solution and the method provides for contacting the substrate with the SPM solution before the SPM solution cools to a temperature below about 95° C. The method further provides for further cleaning the substrate with a water soluble organic co-solvent, and rinsing in deionized water.

According to another aspect, the invention provides a method for cleaning a substrate that includes providing a substrate with photoresist thereon, mixing H₂SO₄ and H₂O₂ to produce an SPM solution, and within 15 minutes of forming the SPM solution, contacting the substrate with the SPM solution, the SPM solution having a temperature greater than about 110° C. The method further provides for further cleaning the substrate with a water soluble organic co-solvent, and rinsing in deionized water.

According to another aspect of the invention, a method for cleaning a substrate comprises providing the substrate with photoresist on a front side thereof, mixing H₂SO₄ and H₂O₂ to produce an SPM solution, and within 15 minutes of mixing to form the SPM solution, contacting the substrate with the SPM solution, the SPM solution having a temperature greater than 110° C., while heating the back side of the substrate to a temperature within the range of 200-500° C. The method further provides for further cleaning the substrate with a water soluble organic co-solvent after the SPM treatment, and rinsing in deionized water.

### DETAILED DESCRIPTION

The present invention provides a method for stripping photoresist and cleaning a substrate using a process sequence of first introducing a hot, freshly mixed SPM (sulfuric peroxide mixture) solution to the substrate at a high temperature, then further cleaning the substrate with a water soluble organic co-solvent.

A semiconductor or other substrate with photoresist or another organic residue thereon, is provided. The substrate may be a substrate upon which semiconductor devices are being formed and it may be a substrate at various stages of the semiconductor device fabrication process. The substrate may be formed of silicon, gallium arsenide, silicon-on-sapphire, indium phosphide, or any other suitable substrate such as used in the semiconductor manufacturing industry. Photoresist is formed on the front, device side of the substrate and there may also be some photoresist on the edges and back side of the substrate which may be various sizes such as a 6, 8, 10 or 12 inch wafer. The photoresist may be a freshly coated layer of photoresist or it may be a freshly patterned photoresist film or it may be the photoresist film remaining on a substrate after a patterning or implantation operation has taken place using the photoresist pattern as a photomask. For example, the photoresist may be a patterned photoresist layer that has served as a photomask during a reactive ion etch, plasma etching operation. Such implantation and plasma etching operations, frequently done in conjunction with pre-bakes, cause the photoresist to become very hard and difficult to remove.

The photoresist removal and substrate cleaning process begins by first subjecting the substrate to a freshly mixed SPM solution. The SPM solution is formed by mixing sulfuric acid, H₂SO₄ with hydrogen peroxide, H₂O₂. Various SPM compositions may be used, but the SPM solution commonly includes H₂SO₄ and H₂O₂ in a 1:3-4 ratio. Other compositions may be used alternatively, however. The mixing procedure, in which the hydrogen peroxide is advantageously added to the sulfuric acid, produces an exothermic reaction which raises the temperature of the formed SPM solution. The temperature of the solution may reach 100° C. and it may reach as high as 120° C. Conventional mixing techniques may be used. Soon after the SPM solution is formed by mixing, prior to decay of the solution and while the solution is still fresh, the substrate with the photoresist is introduced to the SPM solution. In one exemplary embodiment, the SPM solution may be introduced to the substrate within 15 to 30 minutes of mixing and in another exemplary embodiment, an SPM solution not subject to temperature control may be introduced to the substrate before the SPM solution cools to a temperature below 95° C. In another exemplary embodiment, the SPM solution may be heated. The heated SPM solution may be maintained at a temperature of at least 110° C. in one exemplary embodiment.

Various conventional techniques may be used to introduce the SPM solution to the substrate. In one exemplary embodiment, the substrate, or a plurality of such substrates, may be submerged within a bath of the SPM solution. Various techniques may be used to agitate, bubble or cascade the SPM solution resulting in a more aggressive photoresist removal and cleaning procedure. In another exemplary embodiment, automated equipment may be used to direct a stream of the SPM solution to a static, rotating, or otherwise moving substrate. In one exemplary embodiment, the SPM solution may be maintained in a temperature controlled, recirculating bath in which the SPM solution is maintained at an advantageously high temperature such as a temperature of at least greater than 95° C. in one exemplary embodiment or a temperature greater than 110° C. in another exemplary embodiment.

According to an exemplary embodiment, the substrate may be heated to soften the photoresist using conventional methods, to a temperature within a range of 200-500° C. prior to contacting the SPM solution. Conventional methods may be used. In yet another advantageous embodiment, substrate heating may take place while the substrate is being contacted by the SPM solution. The substrate may be disposed within a bath of an SPM solution or the SPM solution may be directed to the front, device side of the substrate while the substrate is simultaneously being heated. In an exemplary embodiment, the back side of the substrate may be heated to a temperature of about 200-500° C. such as by contacting a hot plate. Other temperatures may be used in other exemplary embodiments. The back side heating of the substrate, together with the substrate being simultaneously submerged in, or otherwise contacted by, the freshly poured SPM solution, provides a rapid and efficient photoresist removal process. In various exemplary embodiments, the photoresist removal rate may range up to 6000 angstroms/second. The SPM solution cleaning procedure may take place for various process times determined by photoresist thickness and hardness, SPM solution temperature, and whether or not the substrate is heated. In one exemplary embodiment, the SPM solution cleaning procedure may take place for a time ranging from 30 seconds to 15 minutes, but other times may be used in other exemplary embodiments.

After the SPM solution photoresist stripping and cleaning procedure take place, the substrate is then subjected to an organic solvent cleaning procedure. The organic solvent is advantageously a water soluble organic co-solvent such as acetone, isopropyl alcohol (IPA) methanol, ethanol, butanol, or DMSO (dimethylsulfoxide). An organic co-solvent compound is a material used to dissolve some neutral organic substances, such as in media preparation, and other alcohols not listed above may also be used as organic co-solvents. Various techniques may be used to deliver the organic solvent to the substrate and other suitable organic solvents may be used in other exemplary embodiments. In one exemplary embodiment, the substrate may be immersed within a stagnant, cascading or recirculating bath of the organic co-solvent. In another exemplary embodiment, the organic co-solvent may be introduced to the substrate in an automated processing tool such as one that directs a stream of the organic co-solvent to the substrate which may be held in a static position, rotated or otherwise mechanically moved. In one exemplary embodiment, a high-pressure stream of the organic co-solvent may be directed to the substrate surface upon which the photoresist had been disposed. The stream may include N₂ as a carrier gas. In one exemplary embodiment, the stream pressure may lie within a range of 14.7 to 147 psi (1 to 10 atmospheres), but other pressures may be used in other exemplary embodiments. In another exemplary embodiment, a nanospraying technique may be used to deliver the co-solvent to the substrate. Nanospraying is alternatively referred to as electro spray ionization and involves nebulizing the liquid organic co-solvent solution using a neutral carrier gas such as nitrogen to evaporate the neutral solvent into small droplets. The small droplets are then directed to the surface being cleaned. In another exemplary embodiment, the substrate may be immersed in or otherwise contacting the organic co-solvent and the substrate surface may be simultaneously inundated with a high-pressure N₂ gas flow treatment such as may be used to direct additional co-solvent to the substrate. Various conditions of the N₂ gas flow may be used and various techniques may be used to direct the N₂ gas flow to the substrate surface which is also in contact with the organic co-solvent.

The time for the water soluble organic co-solvent cleaning operation will vary depending on application, the time of the preceding SPM process operation and whether or not the optional nanospraying technique or high pressure N₂ gas is used in conjunction with the organic co-solvent cleaning operation. In one exemplary embodiment, the time for the organic co-solvent cleaning operation may range from 0.5 to 15 minutes. After the organic co-solvent cleaning step, the substrate is thoroughly rinsed using DI water and conventional methods may be used for thoroughly rinsing the substrate with DI water.

The organic co-solvent cleans any remaining photoresist or other organic residue as well as any polymers from the substrate surface providing an ultra clean substrate surface. Regardless of the condition or amount of the photoresist that was originally on the substrate, virtually all of the photoresist is completely removed using the aforementioned processed sequence. The substrate is now ready for subsequent processing.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A method for cleaning a substrate comprising:
providing said substrate;
mixing H₂SO₄ and H₂O₂ together in an exothermic reaction to produce an SPM solution;
contacting said substrate with said SPM solution, said SPM solution having a temperature greater than about 110° C.;
contacting said substrate with a water soluble organic co-solvent; and
rinsing in deionized water.

2. The method as in claim 1, wherein said contacting said substrate with said SPM solution takes place within 15 minutes of said mixing.

3. The method as in claim 1, wherein said contacting said substrate with a water soluble organic co-solvent follows said contacting said substrate with said SPM solution and further comprising said SPM solution being removed from said substrate prior to said contacting said substrate with a water soluble organic co-solvent .

4. The method as in claim 1, wherein said contacting said substrate with a water soluble organic co-solvent further comprises spraying said substrate with high pressure N₂ gas while said substrate contacts said water soluble organic co-solvent.

5. (canceled)

6. The method as in claim 1, wherein said contacting said substrate with a water soluble organic co-solvent comprises delivering said water soluble organic co-solvent to said substrate in a high-pressure stream.

7. The method as in claim 1, further comprising providing said H₂SO₄ and said H₂O₂ and wherein said mixing comprises adding said H₂SO₄ said H₂O₂.

8. The method as in claim 1, wherein said contacting said substrate with a water soluble organic co-solvent comprises delivering said water soluble organic co-solvent to a surface of said substrate using nanospraying techniques.

9. The method as in claim 1, further comprising, prior to said contacting said substrate with said SPM solution, baking said substrate at a temperature within a range of 200-500° C by contacting a hot plate.

10. The method as in claim 1, wherein said contacting said substrate with said SPM solution comprises contacting a surface of said substrate having photoresist thereon, with said SPM solution while simultaneously baking an opposed surface of said substrate by contact with a hot plate, said baking comprising baking to a temperature within a range of 200-500° C.

11. The method as in claim 1, wherein said water soluble organic co-solvent comprises one of acetone, isopropyl alcohol, methanol, ethanol, butanol, and DMSO.

12. The method as in claim 1, wherein said providing a substrate includes said substrate having thereon photoresist having been subjected to at least one of a plasma etching operation and an ion implantation operation and wherein said contacting said substrate with said SPM solution and said contacting said substrate with a water soluble co-solvent completely remove said photoresist.

13. A method for cleaning a substrate comprising:
providing said substrate;
causing H₂SO₄ and H₂O₂ to mix together to produce an SPM solution in an exothermic reaction;
before said SPM solution cools to a temperature below about 95° C., contacting said substrate with said SPM solution;
contacting said substrate with a water soluble organic co-solvent; and
rinsing in deionized water.

14. The method as in claim 13, wherein said contacting said substrate with a water soluble organic co-solvent includes directing said water soluble organic co-solvent to said substrate in a stream of high pressure N₂ gas.

15. The method as in claim 13, wherein said contacting said substrate with said SPM solution comprises contacting a surface of said substrate with photoresist thereon, with said SPM solution while simultaneously baking an opposed surface of said substrate by contact with a hot plate, said baking comprising baking to a temperature within a range of 200-500° C.

16. The method as in claim 13, wherein said contacting said substrate with a water soluble organic co-solvent comprises delivering said water soluble organic co-solvent to a surface of said substrate using nanospraying techniques.

17. A method for cleaning a substrate comprising:
providing said substrate with photoresist on a front side thereof;
mixing H₂SO₄ and H₂O₂ together to produce an SPM solution in an exothermic reaction;
contacting said substrate with said SPM solution thereby removing said photoresist, said SPM solution having a temperature greater than about 110° C. while heating a backside of said substrate to a temperature within a range of 200-500° C.;
delivering a water soluble organic co-solvent to said substrate; and
rinsing in deionized water.

18. The method as in claim 17, further comprising providing said H₂SO₄ to said H₂O_{2.}

19. The method as in claim 17, wherein said contacting said substrate with a water soluble organic co-solvent comprises delivering said water soluble organic co-solvent to a surface of said substrate using nanospraying techniques.

20. The method as in claim 1, wherein said substrate includes photoresist thereon and said contacting completely removes said photoresist from said substrate.

21. The method as in claim 13, further comprising providing said H₂SO_{4 and said H}₂O₂ and wherein
said causing comprises adding said H₂SO₄ to said H₂O₂
said providing said substrate comprises providing said substrate with photoresist thereon, and
said contacting said substrate with said SPM solution completely removes said photoresist from said substrate.
